(19) United States
(12) Patent Application Publication
(10) Pub. No.: US 2009/0309075 A1
(43) Pub. Date: Dec. 17, 2009

(54) USAGE OF BORATE SALTS

(76) Inventors: Jens Röder, Frankfurt (DE); Ulrich Wietelmann, Friedrichsdorf (DE); Rainer Aul, Rodgau (DE); Steffen Haber, Frankfurt (DE)

Correspondence Address: FULBRIGHT & JAWORSKI, LLP, 666 FIFTH AVE, NEW YORK, NY, 10103-3198, US

(21) Appl. No.: 12/439,699

(22) PCT Filed: Sep. 6, 2007
(86) PCT No.: PCT/EP2007/059344

§ 371 Date: May 7, 2009

(30) Foreign Application Priority Data
Sep. 7, 2006 (DE) 10 2006 042 492.1

(51) Int. Cl. H01B 1/12; C08K 5/1565

(52) U.S. Cl. 252/519.21; 524/108

(57) ABSTRACT

The present invention relates to the use of borate salts.

The subject matter of the present invention is the use of borate salts.

In particular, the subject matter of the present invention is the use of borate salts as an additive in synthetic materials, in particular as a stabilizer, a flame-retardant and a conductivity-improver.

To an increasing extent, materials such as stone, ceramics and metals are being replaced by synthetic materials, plastics. The basis of these plastics materials is in the main polymers. The flammability of these new organic materials, however, is a great disadvantage. In order to guarantee a certain flame-retardance, suitable flame-retardants are therefore added to the plastics materials (R. Wolf, Ullmann's Encyclopedia of Industrial Chemistry: Plastic Additives, Flame Retardants, published by Wiley-VCH Verlag GmbH & Co. KGaA, 2000; R. Wolf, B. Lal Kaul, Ullmann's Encyclopedia of Industrial Chemistry: Plastic Additives, published by Wiley-VCH Verlag GmbH & Co. KGaA, 2000).

Inorganic substances, such as aluminum hydroxide, magnesium hydroxide, but also antimony trioxide und antimony pentoxide or barium borates, are usual as flame-retardants, for example. It is known that barium compounds and antimony compounds are toxic. Likewise, red phosphorus, which is also toxic, is used as a flame-retardant.

Furthermore, halogenated hydrocarbons, especially chlorine- and bromine-substituted aromatic and aliphatic substances, are used as flame-retardants. On the one hand, these compounds are very expensive; they also make it difficult to dispose of the plastics materials thermally, since combustion has to be carried out at high temperatures. The waste gases also have to be specially treated in order to prevent the emergence of environmental toxins. It is known that toxins, such as 2,3,7,8-tetrachlorodioxin for example, can develop during the combustion of halogenated hydrocarbons.

Flame-retardants can also be salts of organo-mineral acids. DE-C-196 16 025 discloses aluminum salts of dialkyl phosphinic acids as flame-retardants. Many phosphorus-organic compounds, however, are likewise known for their toxic effect. Known, highly toxic phosphorus-organic compounds are, for example, 4-(nitro-phenyl) diethylthiophosphate (E 605), dimethylphosphoramidocyanic acid ethyl ester (Tabun), methyl fluorophosphonic acid—pinacolyl ester (Soman) und methyl fluorophosphonic acid isopropyl ester (Sarin).

In addition to the disadvantage of the ease of flammability of plastics materials, it is, furthermore, a disadvantage of plastics materials that they are easily charged electrostatically and as a result can give rise to electrostatic discharges. Electrostatic discharges can damage or destroy sensitive electronic components, change or delete magnetic data carriers or, in an inflammable environment, trigger explosions and fire. Each year, in the electronics industry alone, damage of an estimated 40 billion Euro results just through electrostatic discharges. In order to reduce or even avoid the electrostatic charging of plastics materials, the conductivity of plastics materials is increased so that no instances of high charging arise and charges are dissipated before they build up to dangerous magnitudes. This usually happens by means of various quantities and sorts of additives, such as pulverulent carbon black, carbon fibers, metal fibers, metal-coated carbon fibers and metal powders. These additives, however, have the disadvantage that in part they considerably impair the mechanical properties of the plastics materials.

A further disadvantage of plastics materials is that they can thermally decompose during processing. Stabilizers to prevent this are therefore added to the plastics materials. These stabilizers, however, are mostly additives that are based on heavy metals, such as lead or barium, are toxic and are ecologically hazardous.

An object of the present invention is to overcome the disadvantages of the plastics materials used in the prior art as a replacement for materials, such as stone, ceramics and metals.

A primary object of the invention should then be:
to make plastics materials available that are stabilized by the addition of additives;
to make plastics materials available which as a result of the addition of additives that act as flame-retardants are scarcely flammable;
to make plastics materials available whose specific conductivity is increased by the addition of additives that act as conductivity-improvers and thus counteracts static charging;
to make plastics materials available which as a result of the addition of additives when utilizing the plastics materials thermally burn to form ecologically harmless substances.

Surprisingly, this object is achieved by means of the features of the independent claims. Preferably, developments are found in the subclaims.

The object is surprisingly achieved in accordance with the invention by means of the use of salts of bis(oxalato)borate in accordance with Formula I:

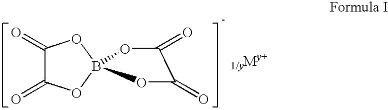

in which M signifies a metal of the periodic system, and y can assume the values 1, 2, 3, 4 or 5, where y corresponds to the respective oxidation stage of the metal M as an additive in polymers.

Examples of M are: Li, Na, K, Rb, Cs, Mg, Ca, Sr, Ba, Fe, Mn, Zn, Al, Ga, In, Sn, Pb. According to the invention, Li, Na, K, Mg, Ca, Fe, Mn, Zn, Al are preferred as M.

The additive in accordance with the invention is suitable equally as a stabilizer, as a flame-retardant and as a conductivity-improver in polymers.

The synthesis and use of different complexes of boron as a basis for the preparation of conducting salts and various additives in the field of battery-development are known: DE-198 29 030 C1 discloses lithium-bis(oxalato)borate (LiBOB), the first boron-centered complex salt described for use as an electrolyte that uses a dicarboxylic acid (in this case oxalic acid) as a chelate component. DE-101 08 592 C1 discloses asymmetrical boron chelate complexes that are well suited as additives in conducting salts.

It is also known that the salts of bis(oxalato)borate are decomposed during combustion to form borate salts and carbon dioxide. Both compounds exhibit flame-retarding properties.

A further advantage of the salts of bis(oxalato)borate is their stability in hydrolysis.

Surprisingly, these properties of the salts of
bis(oxalato)borate also have an advantageous effect in the application in accordance with the invention of the bis(oxalato)borate salts as an additive in plastics materials, without exhibiting the disadvantages of the additives of the prior art.

In so far as there is talk in the following of polyurethanes, their production, processing and use, then this corresponds to the polymer that is known to the person skilled in the art from the literature (N. Adam, G. Avar, H. Blankenheim, W. Friederichs, M. Giersig,. E. Weigand, Michael Halfmann, F.-W. Wittbecker, D.-R. Larimer, U. Maier, S. Meyer-Ahrens, K.-L. Noble, H.-G. Wussow, Ullmann's Encyclopedia of Industrial Chemistry: Polyurethanes, published by Wiley-VCH Verlag GmbH & Co. KGaA 2005).

The subject matter of the invention in detail is:
the use of borate salts as an additive in polymers, with PVC being excluded as a polymer;
the use of borate salts as an additive in polymers, wherein the borate salts are the salts of bis(oxalato)borate in accordance with Formula I:

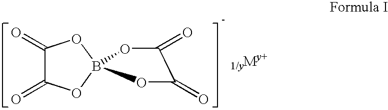

in which M signifies a metal of the periodic system, and y can assume the values 1, 2, 3, 4 or 5, where y corresponds to the respective oxidation stage of the metal M;
the use of borate salts as an additive in polymers, wherein in the case of the borate salts in accordance with Formula I, M is selected from: Na, K, Rb, Cs, Mg, Ca, Sr, Ba, Fe, Mn, Zn, Al, Ga, In, Sn, Pb, preferably from Li, Na, K, Mg, Ca, Fe, Mn, Zn, Al;
the use of borate salts as an additive in polymers, wherein the borate salts in accordance with Formula I are used individually or in a mixture;
the use of borate salts as an additive in polymers, wherein the additive acts as a stabilizer;
the use of borate salts as an additive in polymers, wherein the additive acts as a flame-retardant;
the use of borate salts as an additive in polymers, wherein the additive acts as a conductivity-improver;
the use of borate salts as an additive in polymers, wherein the polymers are polymers of just one polymer sort;
the use of borate salts as an additive in polymers, wherein the polymers are polymers of two or more polymer sorts;
the use of borate salts as an additive in polymers, wherein the polymer consists of uniform monomers;
the use of borate salts as an additive in polymers, wherein the polymer consists of different monomers;
the use of borate salts as an additive in polymers, wherein the polymer contains recycled material and/or is produced from recycled polymers;
the use of borate salts as an additive in polymers, wherein the polymer is selected from polylactate, polyesters such as polyethylene terephthalate (PET), polybutylene terephthalate (PBT), polyethylene naphthenate (PEN), polyamides such as nylon, Nomex, Kevlar, polytetrafluorethene (PTFE, Teflon®), polyolefines such as polyethylene (PE) und polypropylene (PP), polystyrenes, polyacrylates and polyurethanes;
the use of borate salts as an additive in polymers, wherein the polymers are halogenated polymers;
the use of borate salts as an additive in polymers, wherein the polymers are thermoplastic elastomers, preferably butadiene rubber (BR), polyisoprene, butadiene styrene polymers (SBR, SBS-rubbers), natural rubbers or mixtures of two or more of these polymers;
a polymer which contains as an additive one or more borate salts, with PVC being excluded as a polymer;
a polymer which contains as an additive one borate salt or a plurality of borate salts, wherein the borate salt or borate salts are salts of bis(oxalato)borate in accordance with Formula I:

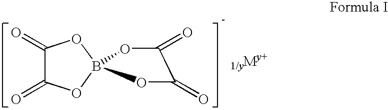

in which M signifies a metal of the periodic system, and y can assume the values 1, 2, 3, 4 or 5, where y corresponds to the respective oxidation stage of the metal M;
a polymer which contains as an additive one borate salt or a plurality of borate salts, wherein the borate salt or borate salts are salts of bis(oxalato)borate in accordance with Formula I, in which M is selected from: Na, K, Rb, Cs, Mg, Ca, Sr, Ba, Fe, Mn, Zn, Al, Ga, In, Sn, Pb, preferably from Li, Na, K, Mg, Ca, Fe, Mn, Zn, Al;
a polymer, in which the additive in accordance with the invention acts as a flame-retardant;
a polymer, in which the additive in accordance with the invention acts as a conductivity-improver;
a polymer which is equipped with an additive in accordance with the invention and contains just one polymer sort;
a polymer which is equipped with an additive in accordance with the invention and contains two or more polymer sorts;
a polymer equipped with an additive in accordance with the invention, in which the polymer consists of uniform monomers;
a polymer equipped with an additive in accordance with the invention, in which the polymer consists of different monomers;
a polymer equipped with an additive in accordance with the invention, wherein the polymer contains recycled material and/or is produced from recycled polymers;
a polymer equipped with an additive in accordance with the invention, wherein the polymer is selected from polylactate, polyesters such as polyethylene terephthalate (PET), polybutylene terephthalate (PBT), polyethylene naphthenate (PEN), polyamides such as nylon, Nomex, Kevlar, polytetrafluorethene (PTFE, Teflon®), polyolefines such as polyethylene (PE) and polypropylene (PP), polystyrenes, polyacrylates and polyurethanes;
a polymer equipped with an additive in accordance with the invention, wherein the polymer is a halogenated polymer;
a polymer equipped with an additive in accordance with the invention, wherein the polymers are a thermoplastic elastomer, preferably butadiene rubber (BR), polyisoprene, butadiene styrene polymers (SBR, SBS-rubbers), natural rubbers and mixtures of two or more of these polymers;
a polymer equipped with an additive in accordance with the invention, in which the further additives are contained;
a polymer equipped with an additive in accordance with the invention in which further additives and/or organic and/or inorganic dyes and/or organic and/or inorganic pigments are added to the polymer for coloring and are incorporated preferably in quantities of 0.0001 to 5% by weight;
a method for producing a polymer equipped with an additive in accordance with the invention, in which the additive in accordance with the invention is added at any point in time—before and/or during—in the production of the polymer and/or during the compounding of the polymer;
a method for producing a polymer equipped with an additive in accordance with the invention, in which the additive in accordance with the invention is added to the polymer in a subsequent step;
a method for producing a polymer equipped with an additive in accordance with the invention, in which the embedding of the additive in accordance with the invention is based on physical forces;
a method for producing a polymer equipped with an additive in accordance with the invention, in which the additive in accordance with the invention is added to the polymer in quantities of 0.0001 to 10, preferably 0.01 to 5%, by weight;
a method for producing a polymer equipped with an additive in accordance with the invention, in which a suitable solvent or suspending agent is added to the additive in accordance with the invention, preferably in order to simplify the entry into the monomer and/or oligomer and/or polymer;
a method for producing a polymer equipped with an additive in accordance with the invention, in which the additive in accordance with the invention is added to the polymer in finely powdered form, with the additive preferably being produced as a finely distributed powder by means of a suitable synthesis process and the grain size being further reduced, if applicable, by means of a suitable grinding process;
a method for producing a polymer equipped with an additive in accordance with the invention, in which the additive in accordance with the invention is added to the polymer in finely powdered form, with the powder being pelletized or granulated or treated in a dust-free manner for improved processability in conjunction with a suitable auxiliary agent, preferably waxes or paraffins and/or oils;
a method for producing a polymer equipped with an additive in accordance with the invention, in which the additives in accordance with the invention are mixed with further additives;
a method for producing a polymer equipped with an additive in accordance with the invention, in which further additives and/or organic and/or inorganic dyes and/or organic and/or inorganic pigments are added to the polymer for coloring and are incorporated preferably in quantities of 0.0001 to 5% by weight;
the use of the polymer equipped with an additive in accordance with the invention for the production of bottles, films, foils, fibrous materials, shaped bodies, shoe soles, foamed materials, polymers with glass-like appearance, automobile tires, rubbers, lacquers, coating powders, pipelines, drinking-water pipes, sewage pipes, profiled sections, profiled window sections, foodstuff packagings, blister packagings and/or industrial plastics materials.

1-28. (canceled)

29. A composition comprising a polymer and a bis(oxalato)borate of Formula: I 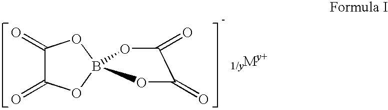
where M is a metal of the periodic system having an oxidation stage, and y is 1, 2, 3, 4 or 5, where y. corresponds to the respective oxidation stage of the metal M, wherein said polymer is not PVC.

30. The composition according to claim 29, wherein M is selected from the group consisting of Li, Na, K, Rb, Cs, Mg, Ca, Sr, Ba, Fe, Mn, Zn, Al, Ga, In, Sn and Pb.

31. The composition according to claim 29, wherein the polymer is a single polymer.

32. The composition according to claim 29, wherein the polymer comprises at least two different polymers.

33. The composition according to claim 29, wherein the polymer is made of uniform monomer.

34. The composition according to claim 29, wherein the polymer is made of different monomer.

35. A composition according to claim 29, wherein the polymer comprises recycled material or is produced from a recycled polymer.

36. A composition according to claim 29, wherein the polymer is selected from: polylactate, polyesters such as polyethylene terephthalate, polybutylene terephthalate, polyethylene naphthenate, a polyamide, Nomex, Kevlar, a polytetrafluorethene, a polyolefine, a polystyrene, a polyacrylates and polyurethane.

37. A composition according to claim 29, wherein the polymer is a halogenated polymer.

38. A composition according to claim 29, wherein a thermoplatic elastomer, butadiene rubber, polyisoprene, a butadiene styrene polymer, a natural rubber or from mixtures of two or more of these polymers.

39. A composition according to claim 29, further comprising a further additives.

40. A composition according to claim 29, further comprising at least one of an additive, an organic dye, an inorganic dye, an organic pigment, or an inorganic pigments.

41. A composition according to claim 29, wherein the polymer comprises at least one member selected from the group consisting of a butadiene styrene polymer, a natural rubber or from mixtures of two or more of these polymers.

42. A composition according to claim 29, wherein the bis(oxalato) borate salt is present in amount sufficient to retard flames when the polymer is exposed to flame.

43. A composition according to claim 29, wherein the bis(oxalato) borate is present in an amount sufficient to increase conductivity of the polymer.
